(19) United States
(12) Patent Application Publication
(10) Pub. No.: US 2016/0088786 A1
(43) Pub. Date: Mar. 31, 2016

(54) ACTIVE COULTER PLANTING SYSTEM

(71) Applicant: The United States of America as represented by the Secretary of Agriculture, Washington, DC (US)

(72) Inventors: Ted S. Kornecki, Auburn, AL (US); Corey M. Kichler, Auburn, AL (US)

(21) Appl. No.: 14/501,594

(22) Filed: Sep. 30, 2014

(51) Int. Cl. A01B 49/06; A01C 5/06; A01B 39/08

(52) U.S. Cl. CPC A01B 49/065; A01B 39/085; A01C 5/064

(57) ABSTRACT

Active coulters are integrated into a planter for a walk-behind tractor. The coulters are “active” (rather than passive) because the coulters are powered (i.e. actively rotated) directly by the walk-behind tractor, rather than passively rolling as the tractor is propelled across a field. The active coulters cut cover crop residue on the surface of the field so that the planter seed drill can plant seeds into the soil beneath the (preferably) flattened cover crop residue on the surface of the field.

The present invention relates to a system and method for planting seeds in a no-till agricultural system. Specifically, the current invention relates to a system for a walk-behind tractor whereby active coulters (that are integrated into a planter) cut and penetrate cover crop residue on a surface of a field and so that the planting planter can plant seeds in the soil below the surface crop residue.

### BACKGROUND OF THE INVENTION

Cover crops are an important part of no-till and minimum-till agricultural conservation systems. For the purpose of this disclosure, the term “cover crops” is defined as referring to crops that are intentionally allowed to remain in a target field as a means of improving growing conditions in the field. Cover crops include crops that are grown for the sole purpose of enhancing growing conditions in anticipation of a subsequently planted cash crop, as well as crop stalks and residue that remain in a field after the harvest of a previous cash crop.

Among other things, cover crops reduce soil erosion, increase soil moisture retention, increase soil organic matter, suppress weeds, and reduce soil compaction. However, these benefits are derived primarily through the cover crop biomass that remains on (or just under) the soil surface after the cover crops are terminated. To plant a subsequent cash crop, a seed drill or other planting mechanism must penetrate the biomass (i.e. “the surface cover crop residue”) and deposit a seed into the soil at a selected soil depth beneath the surface cover crop residue.

Large scale farm systems already use heavy no-till seed drills and associated row cleaning implements that can easily manipulate and manage the surface cover crop residue. These systems easily penetrate surface cover crop residue and allow successful planting of cash crops into heavy cover crop residue. However, on small farms with low-power and light weight tractors, there is no effective planting system available to effectively penetrate the surface cover crop residue and plant a seed into the soil below the surface residue.

Although there are conventional planters on the market that are compatible with walk-behind tractors, the conventional planters are intended for use in tilled and cultivated soil that is ready for planting. These planters typically become entangled in any thick cover crop residue that is not thoroughly mulched or otherwise removed from the surface of the field.

The need exists for a walk-behind tractor planting system that is generally compatible with the existing conventional planter apparatus and is capable of penetrating surface cover crop residue and thereby successfully planting seeds into the soil beneath the cover crop residue. The system described herein comprises an active coulter planter that is compatible with conventional planters currently available for walk-behind tractors and is capable of cutting and penetrating the surface cover crop residue to place seeds at the optimum depth.

### SUMMARY OF THE INVENTION

The current invention is directed to a walk-behind tractor crop planting system. The crop planting system comprises active coulters that are integrated into a planter apparatus. The active coulters cut through cover crop residue on the surface of a field so that the planter seed drill can penetrate the surface cover crop residue and thereby plant a seed into the soil below the cover crop residue.

The current invention is also directed to a method of planting seeds below surface cover crop residue. In accordance with the method, an active coulter system is integrated into a conventional planter so that a combination of the planter and the active coulter system comprises an active coulter planting system. The active coulter planting system is connected to a walk-behind tractor and propelled across a field of cover crops so that the active coulter planting system plants seeds into the soil below the surface cover crop residue.

### BRIEF DESCRIPTION OF THE DRAWINGS

FIG. 1 is a top perspective view of the planter attached to a walk-behind tractor.

FIG. 2 is a top perspective view of the planter showing the drive system for the active coulters.

FIG. 3 is a top rear perspective view of the planter.

FIG. 4 is a top perspective of an alternative embodiment comprising an active coulter planting system that is driven by a tractor power-takeoff.

### DETAILED DESCRIPTION OF PREFERRED EMBODIMENTS

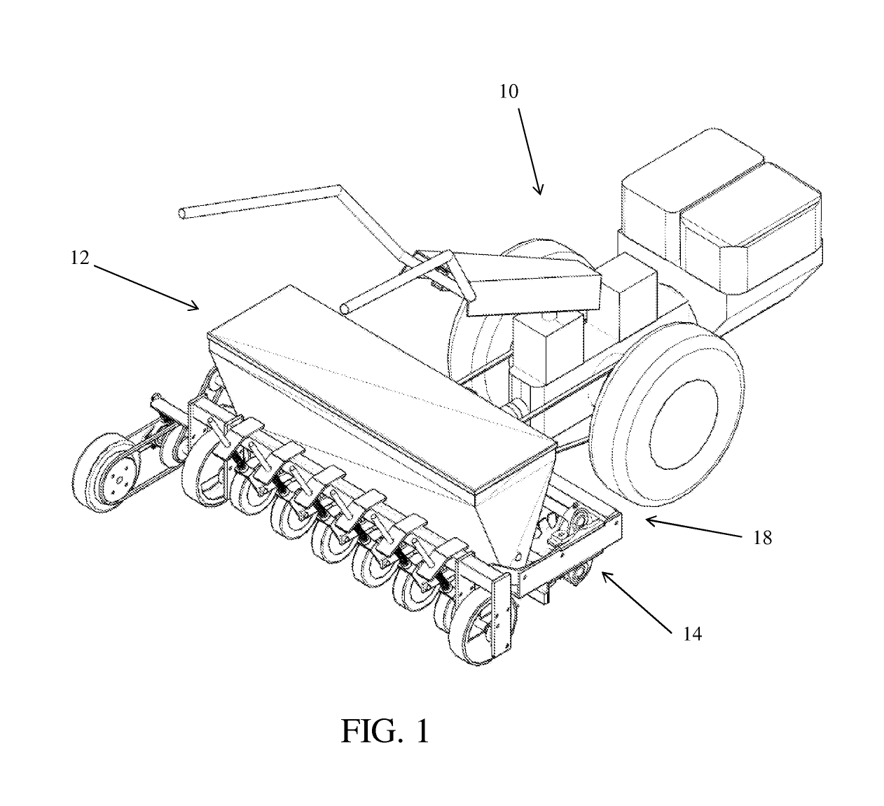

A walk-behind tractor 10 attached to an active coulter planting system 12 is generally shown in FIG. 1. The active coulter planting system 12 generally comprises a conventional walk-behind tractor planter apparatus with an “active coulters assembly” 14 integrated into (i.e. essentially attached to a front portion of) the conventional planter.

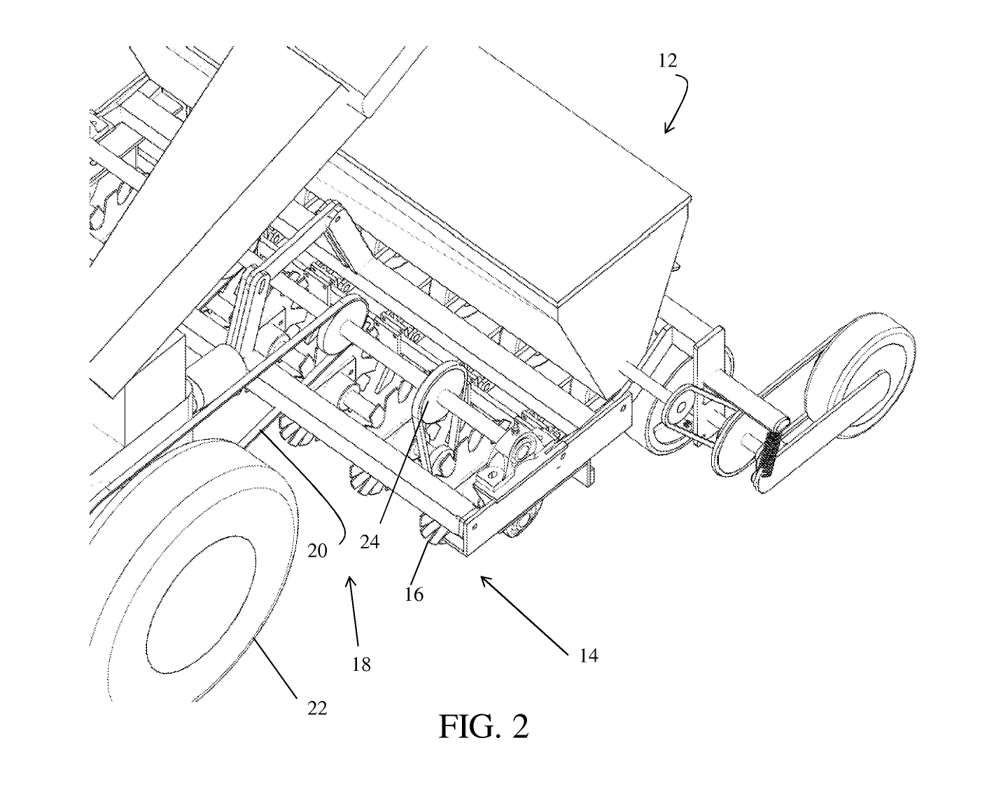

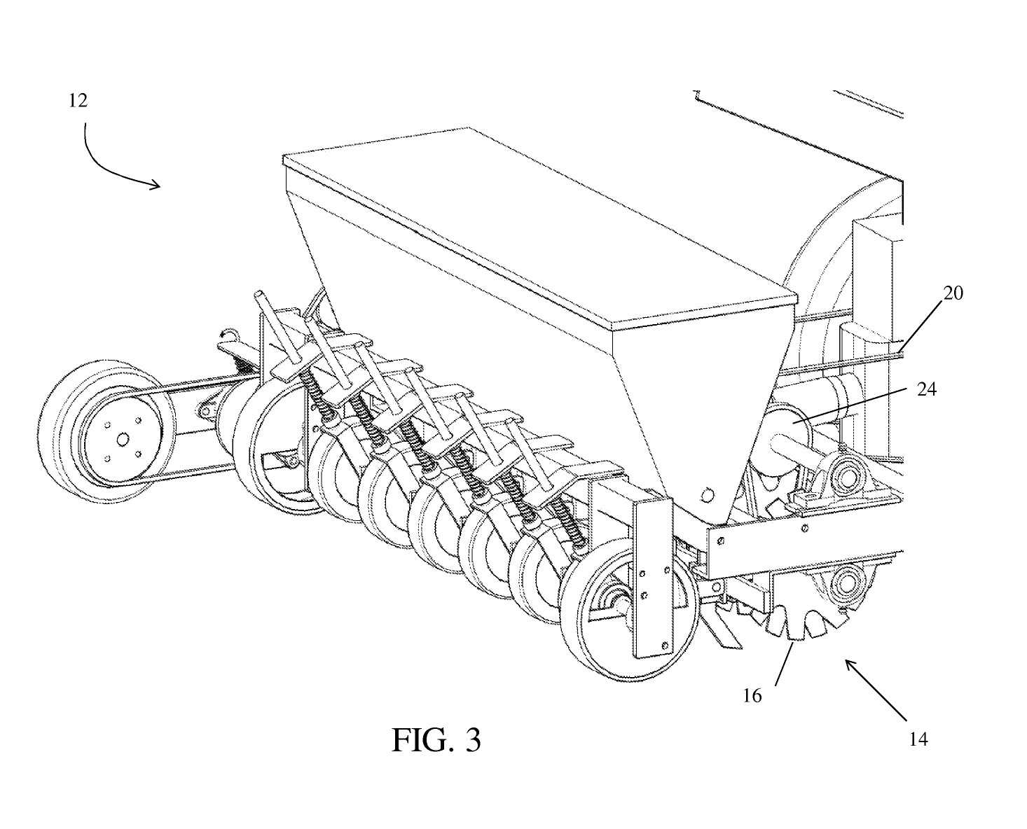

For the purposes of this disclosure, an “active coulter assembly” 14 is defined as an assembly wherein coulters 16 (best shown in FIGS. 2 and 3) are rotated directly by a drive system 18 emanating from (for example) a walk-behind tractor 10. Active coulters 16 may be contrasted with “passive coulters”—which are common in prior art systems. “Passive coulters” are coulters which are not driven by a drive system 18 emanating from a tractor 10. Passive coulters are passively rotated through contact with the ground. The passive coulters essentially roll as an implement comprising the passive coulters is propelled across a field.

For the purposes of this disclosure, a walk-behind tractor 10 is defined as a tractor that does not accommodate a riding operator so that the operator walks behind the tractor 10 and guides the tractor 10 with a linkage that may include handlebars, hand grips, or the like. Typical examples of these types of tractors 10 are manufactured by DR, Troy-Built, and BCS.

As best shown in FIG. 2, the active coulters 16 are driven by a drive system 18 emanating from (preferably) a walk-behind tractor 10. In the preferred embodiment, the drive system 18 comprises belt (or a chain) drive 20 attached to a sprocket or pulley positioned adjacent to the tractor drive wheels 22. The belt/chain 20 transfers the power to the power transmission assembly 24, which actually directs the power to coulters 16.

As shown in FIGS. 2 and 3, in the preferred embodiment, the active coulters 16 comprise double disc coulters. However, in alternative embodiments, the coulters 16 may comprises notched or serrated coulters, or any coulter configuration known is the art consistent with the function of cutting the surface cover crop residue. Note that although notched and/or serrated coulters are not shown in the drawings, they are conventional components that are well known in the art. Their detailed illustration is not essential to a proper understanding of the claimed invention.

Additionally, the power transmission assembly 24 changes gearing ratio of the input power so that (in the preferred embodiment) the active coulters 16 are rotated about four times for every one rotation of the tractor wheel 22. In alternative embodiments, the power transmission assembly may cause the active coulters 16 or rotate more or less than four times for every rotation of the wheels.

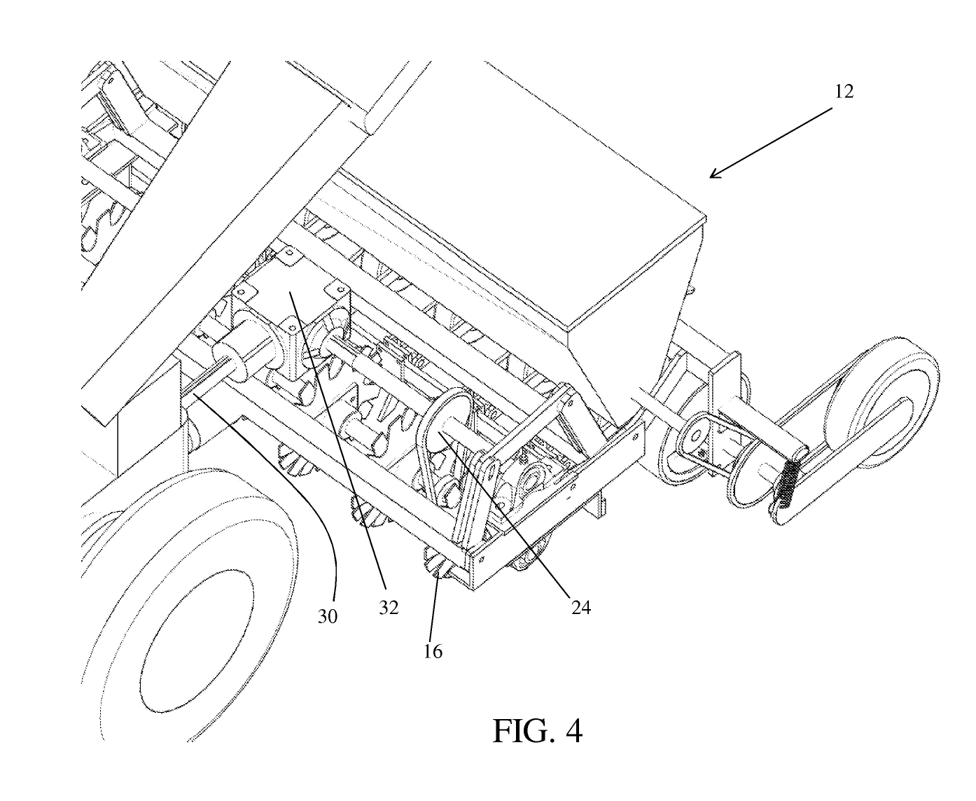

In further alternative embodiments, as shown in FIG. 4, the power to drive the active coulters system 12 may emanate from the tractor 10 power takeoff. In this embodiment, power from the tractor 10 is directed through a power takeoff shaft 30 and into a gear box 32 that drives a modified power transmission assembly 24 and ultimately the coulters 16. In this embodiment, the coulters 16 may be rotated at significantly greater speeds than the embodiment shown in FIGS. 1-3.

In further alternative embodiments, the active coulter assembly 14 may be driven from an auxiliary drive or another power system associated with the tractor 10. Further, the power transmission assembly 24 may have multiple alternative configurations consistent with the function of directing power from the tractor 10 to the active coulter assembly 14. Any configuration of power transmission assembly 24 known in the art should be considered within the scope of the current invention.

In operation, as shown in FIGS. 1-4, as a tractor 10 propels an active coulter planting system 12 across a field of flattened cover crops, power from the tractor drive wheels 22 (or a power takeoff shaft 30) is directed through the a drive system 18 (which includes the power transmission assembly 24) to the active coulters 16 so that the active coulters 16 cut through crop residue on the surface of the field and thereby enable the active coulter planting system 12 to plant a seed into the soil below the surface crop residue.

For the foregoing reasons, it is clear that the current invention provides an innovative means of planting seeds below crop residue using a walk-behind tractor-based planting system. The invention may be modified in multiple ways and applied in various technological applications. The current invention may be customized as required by a specific operation or application, and the individual components may be modified and defined, as required, to achieve the desired result.

For example, although the preferred embodiment is intended for use with a walk-behind tractor, in alternative embodiments the scale of the components may be increased or decreased. An implement with the design described herein may be used with other types of powered devices including conventional riding-type farm tractors as well as devices that would not conventionally be considered to be “tractors”(such as all-terrain vehicles (ATVs)). Such variations are not to be regarded as a departure from the spirit and scope of the invention, and all such modifications as would be obvious to one skilled in the art are intended to be included within the scope of the following claims.

What is claimed is:

1. A walk-behind tractor crop planting system, wherein active coulters integrated into a planter apparatus cuts crop residue on a surface of a field so that a seed is planted by the planting system below the surface of the field.

2. The crop planting system of claim 1 wherein the active coulters are operatively connected to and driven by a drive system emanating from the walk-behind tractor's wheels.

3. The crop planting system of claim 1 wherein the active coulters are driven by a drive system comprising a tractor-driven power takeoff, the power takeoff driving a gear box that transmits power to the active coulters.

4. The crop planting system of claim 1 wherein the active coulters are mounted on a front of the planter.

5. The crop planting system of claim 1 wherein the active coulters comprise single or double disc coulters.

6. The crop planting system of claim 1 wherein the active coulters comprise notched, toothed, serrated, and/or smooth and sharpened coulters.

7. The crop planting system of claim 1 wherein a power transmitting assembly modifies a transmission of power from the tractor to the active coulters so that for every revolution of wheels of the walk-behind tractor, the active coulters rotate at least twice.

8. The crop planting system of claim 1 wherein a power transmitting assembly modifies a transmission of power from the tractor to the active coulters so that for every revolution of wheels of the walk-behind tractor, the active coulters rotate about four times.

9. A method of planting seeds comprising:
(a) providing the crop planting system of claim 1; and
(b) propelling the crop planting system across a field of cover crops so that the seeds are planted below the surface of the field.

10. A method of planting seeds below surface cover crop residue, the method comprising the steps of:
(a) providing a planter;
(b) integrating an active coulter system into the planter so that a combination of the planter and the active coulter system comprises an active coulter planting system; and,
(c) connecting the active coulter planting system to a walk-behind tractor and propelling the active coulter planting system across a field of flattened cover crops so that the active coulter planting system plants seeds below the surface cover crop residue.

11. The method of claim 10 wherein, in step (b), active coulters of the active coulter system are operatively connected to and driven by a drive system emanating from the walk-behind tractor's wheels.

12. The method of claim 10 wherein, in step (b), the active coulters are driven by a drive system comprising a tractor-driven power takeoff, the power takeoff driving a gear box that transmits power to the active coulters.

13. The method of claim 10 wherein, in step (b), the active coulters system is mounted on a front portion of the planter.

14. The method of claim 10 wherein, in step (b) active coulters of the active coulter system are double disc, notched, and/or serrated coulters.

15. The method of claim 10 wherein, in step (b), a power transmitting assembly modifies a transmission of power from the tractor to the active coulters so that for every revolution of wheels of the walk-behind tractor, the active coulters rotate at least twice.

16. The method of claim 10 wherein, in step (b), a power transmitting assembly modifies a transmission of power from the tractor to the active coulters so that for every revolution of wheels of the walk-behind tractor, the active coulters rotate four times.
